(19) United States
(12) Patent Application Publication
(10) Pub. No.: US 2002/0036158 A1
(43) Pub. Date: Mar. 28, 2002

(54) Batch process for refining used oil

(76) Inventor: Douglas P. Austin, Salt Lake City, UT (US)

Correspondence Address: THORPE NORTH WESTERN, 8180 SOUTH 700 EAST, SUITE 200, P.O. BOX 1219, SANDY, UT, 84070, US

(21) Appl. No.: 09/923,154

(22) Filed: Aug. 6, 2001

Related U.S. Application Data
(60) Provisional application No. 60/223,840, filed on Aug. 8, 2000.

(51) Int. Cl. C10M 175/00; B01D 11/00; B01D 3/00; B01D 3/10; B01D 3/42

(52) U.S. Cl. 208/184; 208/179; 196/14.52; 196/46; 196/98; 196/114; 196/124; 196/132

(57) ABSTRACT

A method for separating used oil in a simple batch process into usable fractions. A pretreatment step involves forming a mixture of the used oil and specified pretreatment chemicals. A reduced pressure is maintained throughout the process along with mixing of the formed mixture. Heat is applied at a predetermined rate corresponding to vaporization and recovery of usable fractions of aqueous, light hydrocarbons, base oil, and a pumpable residual. Each distillate fraction is removed as a vapor, condensed and collected. Undesirable cracking is avoided by maintaining a reduced pressure and avoiding rapid or localized heating within the mixture by mixing during the distillation process. The resulting aqueous and light fractions can be reused in the process or otherwise used. The pumpable residual can also be sold as a high quality asphalt extender. The recovered base oil fraction may be sold as a diesel fuel extender, lubricant, catalytic cracker feed stock, or #4 fuel oil for stationary power generators. The base oil fraction may also be further refined using NMP, lower alkanols, and/or water in a solvent extraction process. The described extraction process uses reduced solvent to base oil ratios and has significantly reduced residual solvent in the raffinate. The process effectively breaks the emulsion of used oil into usable fractions with minimal additional cracking or production of undesirable deposits or aromatics.

### PRIORITY INFORMATION

This application is filed claiming priority of provisional application 60/223,840 filed Aug. 8, 2000.

### FIELD OF THE INVENTION

This application relates to a method for separating used motor oils into useful components by a simplified process wherein emulsions within the used oil are broken allowing the distillation and recovery of various aqueous and hydrocarbon fractions. More particularly, this invention relates to a method for separating used motor oils wherein the major oil fraction is recovered for use, such as #4 fuel oil or a diesel fuel extender.

### BACKGROUND ART

Each year over 20 million tons of used lubricating oils are produced throughout the world. Most of this used oil is disposed of in environmentally hazardous ways such as burning or dumping. This used oil represents a vast resource for recovery of useful compounds that currently lacks significant economic incentive to recover.

Lubricating oils are initially a mixture of hydrocarbons and performance enhancing additives. Early in the last century techniques for refining used oil were relatively simple and constituted acid treatment processes. However, many additives are now used to enhance various properties of base engine oil such as rust inhibitors, antioxidants, detergents, viscosity index improvers, and antifoaming agents. The addition of these additives has the effect of creating strong emulsions which make separation very difficult. To complicate the refining process, degradation and thermal breakdown of the base oil and the additives creates a complex mixture of aqueous-organic emulsions. New oil contains approximately 70 to 90% by weight aliphatics as compared to about 60 to 80% in used oil. Used oil also contains as much as 20% by weight aromatic compounds. In addition the used oil emulsion may contain water, gasoline, antifreeze, polymers and trace metals such as zinc, magnesium, barium, lead, aluminum, chromium, copper, iron, manganese, nickel, silicon, and tin depending on the condition of the engine the oil was used in.

One of the most difficult challenges of refining used oil is removing the metallic impurities and the additives which cause polymerization and cracking. Current methods suffer from difficulties of side reactions, heavy fouling, and polymerization on process equipment.

One method of refining used oil involves using liquid propane as a solvent to extract the oil in a continuous process from asphaltic and oxidation products as disclosed in U.S. Pat. Nos. 2,070,626 and 3,773,658. Another process uses vacuum distillation to de-asphalt petroleum or used mineral oils. In U.S. Pat. No. 4,265,734 the oil is injected under pressure into the liquid propane in a pulsed manner.

Vacuum distillation using thin film evaporators followed by hydrotreating is another continuous method for refining used oil. In this process, the oil is heated in successive steps to remove water, then diesel fractions, and then distilled at low pressures to separate the additives from the base oil. Again, this process suffers from the problems of fouling and corrosion caused by the high temperatures in the final distillation column. Thin film evaporators also are typically very expensive to build and often produce low quality distillate oil.

U.S. Pat. Nos. 5,066,386 and 5,286,380 disclose a process for breaking a stable aqueous-oil emulsion by adding a hydrocarbon solvent under high pressure causing some oil to dissolve in the solvent phase, removing some of the solvent phase, and then reducing the pressure at which point the emulsion breaks into water and organic phases. Another method for breaking an emulsion of water, oil, and solids is by physical rolling as discussed in U.S. Pat. No. 6,214,236.

Another process described in U.S. Pat. No. 6,174,431 involves pretreatment of the used oil with a basic solution and a phase transfer catalyst under low heat. The pretreated oil is then non-turbulently mixed with liquid propane and impurities are allowed to precipitate out of the mixture.

Many current methods for refining used oils suffer from cracking, polymerization deposits, low product quality, and/or high expense. There remains a need for a simple, inexpensive method for breaking the stable aqueous-organic emulsion of used oil and recovering usable products that are free of undesirable impurities, which this invention satisfies.

### SUMMARY OF THE INVENTION

Recognizing a need for an improved used oil refining method it is, therefore, a general object of the present invention to provide a novel system and method which avoids or reduces many of the problems noted above.

The present invention relates to a method of refining used oil of variable composition by a temperature controlled batch distillation process under reduced pressure and internal agitation. Due to the highly variable composition of used oil the traditional methods of refining, such as continuous distillation and thin film evaporation, require constant adjusting of the process and expensive processing. The increase in the use of additives in oil has greatly increased the difficulty of separating and refining the used oil. Additionally, as the oil is used, weathering produces significant amounts of aromatic hydrocarbons. Oil additives and engine wear also contribute various trace metals and compounds to the used oil. The invention described herein reduces these problems by using a batch distillation process which is readily adaptable to the handling of varying feed stocks with minimal supervision and separating usable fractions from the used oil.

It is an object of the present invention to provide a process for breaking the strong emulsion of used oils to allow economical recovery of base oil and other constituent compounds. For example, the addition of pretreatment chemicals such as: diesel fuel, naphtha, and/or surfactants in combination with vigorous mixing has been found very effective in attaining this objective.

It is another object of the present invention to recover a base oil suitable for use as a lubricant, fuel additive, catalytic cracker feed stock, or as #4 fuel oil for energy production. An important feature of this object is that the distillation and heating occur under reduced pressure to minimize undesirable thermal degradation and pyrolysis.

It is yet another object of the present invention to provide refined used oil without causing thermal degradation of hydrocarbons or pyrolysis and leaving an asphaltic residual bottoms which is pumpable and easily transported.

It is still another object of the present invention to further purify the recovered base oil using N-methylpyrrolidone (NMP) or NMP and a polar solvent mixture in a solvent extraction process resulting in high quality base oil which is similar to virgin base oil stock. The polar solvent may be water, a lower alkanol or any combination thereof. For example, after distillation the base oil is treated with the NMP/lower alkanol solvent and then allowed to separate through either traditional gravity or centrifuge methods. By adding the polar solvent such as a lower alkanol the amount of solvent remaining in the base oil is so low, as compared with other solvent extraction that re-distilling of the base oil to remove solvent is not required. Moreover, in both NMP and NMP/polar solvent mixtures the solvent to base oil ratio is significantly lower than in previous solvent extraction methods thereby resulting in greater efficiencies and cost saving.

These and other objects, features, and advantages of the present invention will become apparent with reference to the following detailed description and routine experimentation in connection with the accompanying drawings to one skilled in the relevant art.

### BRIEF DESCRIPTION OF THE DRAWINGS

FIG. 1 is a flowchart illustrating an embodiment of the process of breaking the emulsion of used oil and the recovery of usable fractions therefrom.

FIG. 2 is a schematic illustration of one embodiment showing a batch distillation system in accordance with the present invention.

### DETAILED DESCRIPTION

Before the system and methods are disclosed and described, it is to be understood that this invention is not limited to the particular steps and components disclosed herein or in the accompanying figures, but is extended to equivalents thereof as would be recognized by those ordinarily skilled in the relevant arts. It should also be understood that terminology employed herein is used for the purpose of describing particular embodiments only and is not intended to be limiting. In describing and claiming the present invention, the following terminology will be used.

The singular forms “a,” “an,” and “the” include plural referents unless the context clearly dictates otherwise. For example, using “a mixer” would also include using multiple mixers.

As used herein, “base oil”, “recovered base oil”, and “vacuum gas oil” or any other combination of base oil or gas oil are used interchangeably and refer to the final distillate product recovered from this process and is the primary product.

As used herein, “diesel fuel” refers to a crude oil distillate having carbon numbers predominantly in the range of C₁₅ to C₂₅ and a boiling point (at atmospheric pressure) in the range of approximately 300° to 700° C., including at least any of the following: Grades 1-D, 2-D, 3-D, 4-D, and heating oils of similar properties.

As used herein, “naphtha” refers to either the light hydrocarbons recovered from the process or is primarily made up of hydrocarbons of C₁₈ and below having a boiling point not greater than that of kerosene, i.e. #1 diesel fuel.

As used herein, “reduced pressure”, “vacuum” and the like is intended to mean a pressure lower than ambient pressure (about 29.9 inches Hg). Typically, the reduced pressure used herein will be between about 15 and 28 inches Hg.

As used herein, all pressures cited are referenced at standard atmospheric pressure at sea level. Adjustment of corresponding temperatures and pressures at differing elevations is easily determined by those skilled in the art.

As used herein, any percentage is taken to be percent by volume unless expressly stated otherwise. For example, “3 to 10% water” indicates that water constitutes from 3 to 10 percent by volume of the total composition being identified.

Also, the method described herein would be useful for de-emulsifying any number of mixtures of oil, water, emulsified refining residuums, and additives or contaminants. Preferably, the method is used to refine used lubricating oil.

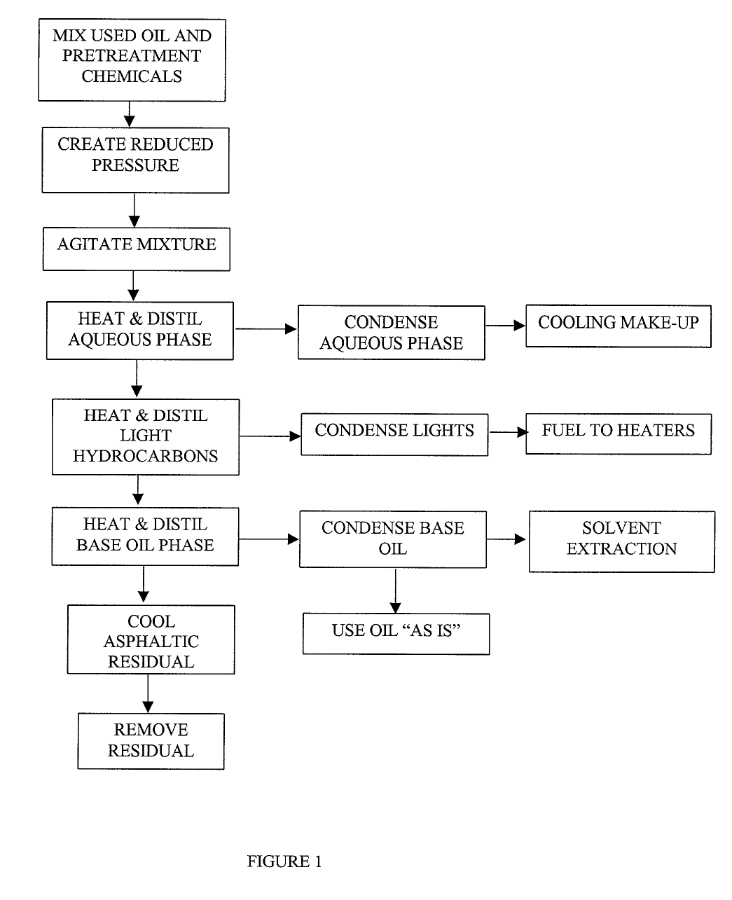

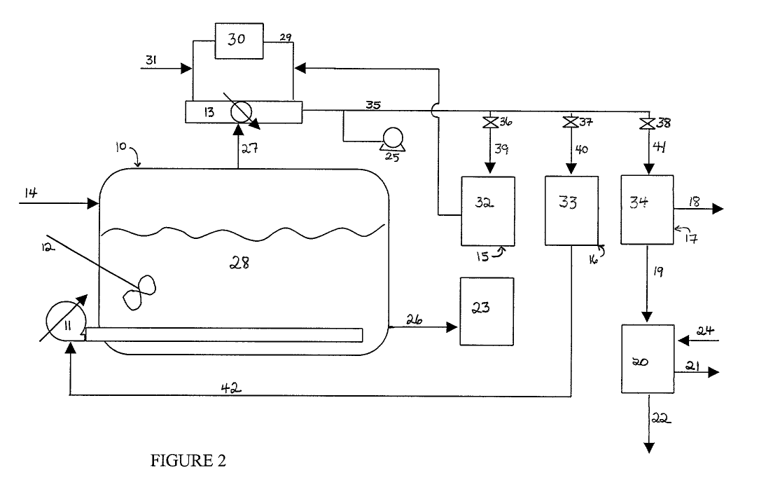

Turning now to the flow diagram of FIG. 1, which is correlated with the system shown in FIG. 2, used motor oil and pretreatment chemicals are added to mixing tank 10 via line(s) 14 to form an unrefined processable liquid mixture 28. As this is a batch process, the relative amounts of used oil and pretreatment chemicals are monitored and added via line 14 at the desired concentrations until the amount added to tank 10 reaches the desired volume. While shown as entering through line 14, the pretreatment chemicals may be added separately to tank 10 or mixed prior to entering the tank 10. Although optimal conditions are sill being explored, typically about 0.5 to 10% by volume of the batch mixture 28 will be pretreatment chemicals. The pretreatment chemicals will comprise #1 diesel fuel, #2 diesel fuel, or naphtha as the primary component to which may, or may not, be added surface active agents, such as a nonionic detergent available under the tradename Tergitol (an ethyloxylated alkyl phenol). Other solvents such as gasoline, propane, butane, pentane, hexane, water, and acetic acid can also be used but are less preferred. Such solvents as lower alkanols, e.g. methanol and isopropyl alcohol can also be added but are more expensive and may oxidize the distillate.

Once tank 10 receives the desired batch volume of used oil and pretreatment chemicals line 14 is closed by a valve (not shown) and a vacuum pump 25 or other suitable method is activated to provide reduced pressure throughout the system. The liquid mixture 28 in tank 10 is under constant agitation by a mixer 12, is slowly heated in a controlled manner by a heating tube 11 or other appropriate heating method, and is maintained under the reduced pressure. The combination of heating, reduced pressure and agitation causes the de-emulsification of the used oil to proceed to completion without cracking of the oil and the formation of undesirable by products such as hydrogen sulfide, olefins and aromatics. Maintaining a reduced pressure is important in avoiding these undesirable reactions, which have occurred at pressures as low as 5 to 6 psig. Any reduced pressure that is functional to attain the desired results is within the scope of this invention. Generally, the reduced pressure will be in the range of about 15 to 28 inches Hg with pressures of about 22 to 26 inches Hg being preferred. Significantly breaking the emulsion early in the process aids in avoiding these undesirable effects.

In one aspect of the present invention, the heating is accomplished using a U-shaped heating tube 11 placed horizontally inside the tank. Other suitable heating devices, placed inside or outside the tank, may also be used and may include without limitation non U-shaped heaters, electric heaters, or hot oil heaters. In another aspect of the invention, the agitation is accomplished using two paddle-style mixers 12 (not specifically shown), one placed above and one placed parallel or below the heater 11. Other embodiments could use propeller, shaking, spraying, pump circulation, auger-style mixers, or any method of mixing sufficient to produce the desired separation result. The combination of heating and vigorous mixing helps to evenly heat the mixture and avoid localized areas of overheating which could cause cracking and aids in physically breaking the emulsion. Vigorous mixing during the process also improves the liquid-vapor separation during distillation. Therefore, any device or combination of devices for heating and mixing which accomplish the desired separation, mixing, and heat transfer results could be used in the present invention.

As the temperature of the mixture 28 in tank 10 is raised to about 100° to 200° F. an aqueous based first volatile component 32 from the de-emulsified mixture is distilled off and exits the tank 10 via line 27 into a stripper/condenser 13 maintained at a relatively constant temperature of about ambient to 130° F. by means of circulating water. The condenser may include both a stripping column and a vapor condenser, however any apparatus that accomplishes a similar condensing effect will satisfy the present invention. The water is circulated in a closed loop 29 and may pass through a cooler 30 as necessary. Makeup water may be introduced into the loop at line 31 as is necessary. However, the first phase aqueous distillate 32 recovered from collection vessel 15, as will be explained, may provide sufficient cooling water that any additional makeup water will be minimal. The aqueous distillate exiting the condenser 13 passes through exit line 35 where it is directed through valve 36 in line 39 into a first collection chamber 15 from which it may be recirculated as cooling water back to condenser 13 or otherwise disposed of. The aqueous distillate is of sufficient quality that little, if any, treatment is necessary to use it as makeup cooling water.

Distillate removed from tank 10 at 200° F. or below is prevented from entering collection vessels other than vessel 15 by means of closed valves 37 and 38 in lines 40 and 41. Distillation is continued at a temperature of about 200° F. and monitored until the aqueous distillate 32 entering collection vessel 15 has essentially ceased. This aqueous distillate generally comprises about 1 to 10% by volume of the original oil treatment chemical mixture, but may vary somewhat above and below this range depending on the original oil and pretreatment mixture.

Upon completion of the aqueous phase distillation, valve 36 is closed and valve 37 in line 40 is opened and the temperature of the mixture 28 in tank 10 is slowly raised from about 200° F. to about 500° F. by heater 11. The mixture in tank 10 remains under reduced pressure and is constantly being stirred or agitated. At temperatures between about 200° -500° F. the volatile components exiting tank 10 via line 27 into condenser 13 comprise a light hydrocarbon fraction 33 primarily made up of hydrocarbons of C₂₀ and below having a boiling point not greater than that of diesel. This light hydrocarbon fraction may contain de-emulsified motor oil additives or added pretreatment chemicals such as naphtha, diesel, ethers, glycols, alcohols, ketones, cosolvents, copolymers, etc. as well as other straight and branched chained hydrocarbons. Thus, this fraction includes any diesel added initially as a pretreatment chemical or solvent to aid in the breaking of the emulsions in the used motor oil feedstock and is recovered in this step and not wasted. It is again to be emphasized that by conducting the distillation process under reduced pressure, under constant agitation and by slowly raising the temperature, cracking of the de-emulsified oil additives is prevented as is the formation of olefins and aromatics. Light hydrocarbon fractions 33 pass from line 35, through open valve 37 and line 40 into collection vessel 16 from which it may be removed via line 42 and used as a fuel source for heater 11 or collected and utilized in any other desired manner. If the light hydrocarbon fraction 33 is used as a fuel source, the process requires minimal additional energy beyond the electricity required to run the pumps and other basic equipment. Distillation of light hydrocarbon phase 33 continues until a temperature of about 500° F. is reached whereupon valve 37 in line 40 is closed. The light hydrocarbon phase 33 generally comprises about 2 to 8% by volume of the initial motor oil treatment chemical mixture 28, but may vary somewhat above and below this range depending on the original oil and pretreatment mixture.

Upon completion of the light hydrocarbon phase distillation, valve 37 is closed and valve 38 in line 41 is opened and the temperature of the mixture 28 in tank 10 is slowly raised from about 500° F. to about 700° F. by heater 11. As in previous steps, the mixture in tank 10 remains under reduced pressure and is constantly being stirred or agitated. At temperatures between about 500° -700° F. the volatile components exiting tank 10 via line 27 into condenser 13 comprises a base oil hydrocarbon fraction 34 primarily made up of hydrocarbons of C₂₀ and above having a boiling point greater than that of diesel. It is again to be emphasized that by conducting the distillation process under reduced pressure, under constant agitation and by slowly raising the temperature, cracking is prevented as is the formation of olefins and aromatics. The base oil hydrocarbon fraction 34 passes from line 35 into collection vessel 17 from which it may be removed via line 18 and used. This base oil hydrocarbon fraction is suitable for direct use as a fuel additive to be blended with #1 or #2 diesel fuel. The recovered base oil 34 may also be used for a variety of other purposes such as energy production, catalytic cracking feed stock, or utilized as a feedstock for further refining and/or purification as will be explained below. Distillation of base oil hydrocarbon phase 34 continues until a temperature of about 700° F. is reached whereupon valve 38 in line 41 is closed and the heating is discontinued. Temperatures over about 740° F. are undesirable because of thermal degradation of hydrocarbons. At this point the vacuum pump 25 is also turned off and ambient pressure is attained in tank 10. The base oil hydrocarbon phase generally comprises about 60 to 90% by volume of the initial motor oil treatment chemical mixture, but may vary somewhat above and below this range depending on the original oil and pretreatment mixture.

Upon cooling, the residue remaining in tank 10 is more flowable than typical refining bottoms, and may be drained via line 26 into collection vessel 23 and utilized as an asphaltic residue for making of asphalt or other heavy hydrocarbon containing products. The asphaltic residue may also contain additives of known or unknown origins, such as metals and polymers that were contained in the used motor oil. The presence of such materials in the asphaltic residue does not prevent its usefulness in making asphalt or other similar type products. The asphaltic residue generally comprises about 15 to 30% by volume of the initial motor oil treatment chemical mixture, but again may vary somewhat above and below this range depending on the original oil and pretreatment mixture.

During the distillation of each fraction of aqueous 32, hydrocarbons 33, and base oil 34 are recooled from vapor to liquid and the temperature of the liquid further reduced using the condenser 13 and then collected in separate vessels. In keeping with the present invention, the distillation occurs without the use of traditional heat exchangers which is advantageous since it has been found that even low pressures required to create flow through traditional heat exchangers will cause cracking of the distillates and subsequent fouling of the system.

The above recited temperatures and time periods will vary somewhat depending on the characteristics of the feed stock and other operating conditions, and are only provided as an operating example. It has been found that excessive rapid heating of the mixture 28 in the tank 10 increases the amount of cracking and undesirable byproducts and is one factor which should be considered as to heating rates. Also, the three noted temperature ranges and resulting distillate products are not limiting, and as such the process may be further subdivided to obtain more than three distillate fractions. Suitable adjustment to these variables is a matter of judgment and appropriate temperatures and rates can easily be selected by one skilled in the art.

The batch size may vary and is based on the desired output and is only limited by that which is functional. Batch sizes of between about 2,000 and 20,000 gallons are contemplated, however larger systems may be built. A typical total batch process time for 10,000 gallons is under 24 hours and preferably 12 to 16 hours.

The recovered base oil 34 in vessel 17 may be optionally further refined using a solvent extraction process to remove sulphur, nitrogen, colorants, residual aromatics, and other contaminants. The treatment of lubricating oils or other base oil fractions to remove undesirable constituents is known in the art. Perhaps the solvent most commonly used is N-methyl pyrrolidone (NMP) or N-methyl-2-pyrrolidone. Such treatment improves the viscosity index, color, oxidative stability, thermal stability, and inhibition response of the treated oil. However, the use of other solvents such as furfural, phenol, sulfolane, water, dimethyl sulfoxide, dimethyl formamide, and N-mercaptoalkyl-2-pyrrolidones is also known.

Solvent to oil volume ratios are generally about 3:1 in known processes. The solvent and oil are mixed and the undesirable constituents and color bodies phase separates with the solvent phase from the oil or distillate. The solvent phase containing contaminants, or extract phase and the base oil phase, or raffinate, are in direct liquid-liquid contact. Although batch mixing tanks may be used, many continuous extraction processes take advantage of counter-current vessels. Traditional NMP solvent extraction processes are performed at solvent to oil volume ratios from about 1:1 to 5:1 and temperatures of about 60° to 100° C. However, when using NMP as the only solvent in the extract phase there is a residual amount of solvent that remains in the raffinate, usually about 3-5% of the solvent. Further, as solvent to oil volume ratios fall below 1:1, i.e. less solvent than oil, the extract phase and raffinate phase become more miscible because of a decreased density difference. This has the adverse effect of significantly slowing the phase separation and extraction process. The solvent containing the undesirable components and the base oil containing residual solvent are then usually re-distilled to recover the solvent. This requires an extra step and is both inefficient and expensive.

It has been found that solvent solubility in the raffinate may be reduced by forming a mixture of NMP and a polar solvent, e.g. water and/or a lower alkanol such as methanol, ethanol, propanol or isopropanol. Additionally, it has been found that by adding a polar solvent such as a lower alkanol or water, less solvent can be used, i.e. the base oil to solvent ratios can essentially be reversed from that given above to about three parts oil to one part solvent. Generally speaking, the oil to solvent ratio will be between about 4:1 to 2:1. The mixed solvent will generally contain between about 50-90% by volume NMP and 10-40% by volume of the polar solvent and preferably lower alkanols. The mixture is formed at temperatures which are below the complete miscibility temperature of the base oil in the solvent. Surprisingly, the addition of the water and/or lower alkanols to the NMP based solvent has the advantage of decreasing the miscibility of the solvent in the raffinate phases and significantly decreasing or eliminating the amount of solvent in the raffinate. The following table illustrates the results of initial tests on a base oil processed according to the above described distillation procedure.

TABLE 1

| | % | % | % | % NMP |
|---|---|---|---|---|
| Test | NMP | Methanol | Isopropanol | Loss |
| 1 | 100 | | | 4 |
| 2 | 100 | | | 5 |
| 3 | 90 | 10 | | 3 |
| 4 | 75 | 25 | | 0 |
| 5 | 50 | 50 | | 0 |
| 6 | 75 | | 25 | 0 |
| 7 | 50 | | 50 | 2 |

In the results reported in Table 1, the volumetric ratio of base oil to solvent was 3:1. As this table shows, the alkanol blended NMP reduces the residual solvent remaining in the base oil, thereby eliminating the need to redistill the base oil to remove solvent. This reduces both the operating cost and capital cost of equipment when solvent extracting refined used oil fractions.

In practice, the solvent/alkanol blend is added via line 24 to the recovered base oil in a vessel 20. The NMP/alkanol blend may then be separated from the refined base oil through either allowing the NMP/alkanol blend to phase separate using gravity or by applying centrifugal force. The purified base oil phase can then be separated by decanting the base oil via line 21 and the solvent can then be removed from tank 20 via line 22. Any other suitable separation means known in the art for phase separation may also be used. If necessary, any solvent remaining in the base oil may be recovered by separately distilling the base oil in a separate system to remove the solvent. In practice however, the only solvent separation required will be the separating of the undesirable components from the solvent following extraction. This may be accomplished by techniques known in the art including filtering out particulate matter and, if necessary distilling the solvent from any remaining residue.

The following example illustrates one result following the present invention for refining a quantity of used motor oil into usable fractions. The following example should not be considered as limiting of the present invention, but should merely teach the methods of the present invention.

### EXAMPLE

The batch mixing tank was filled with 10,000 gallons of used motor oil. About 100 gallons of #2 diesel fuel was added as a pretreatment chemical. A reduced pressure of 24 in Hg (at 4,200 feet above sea-level) was maintained throughout the system using a vacuum pump. The mixture was continuously mixed using two paddle mixers at a rate of about 50 rpm. The temperature of the mixture was raised to 200° F. and maintained for about 3 hours. The collected aqueous phase represented 3% of the original mixture volume and was used as cooling makeup water. The temperature was then raised to 500° F. and maintained for about 5 hours. The collected light hydrocarbon distillate represented 5% of the original mixture, with 2% constituting cosolvents and 3% diesel, a portion of which was used as fuel for the heater. The temperature of the mixture was further heated to 700° F. and maintained for about 8 hours. The collected base oil distillate represented 67% of the original mixture volume. The remaining 25% volume of residual in the tank was then drained.

The invention as described thus can refine used oil of widely variable composition. The process may also be stopped and restarted in a short time period without adverse effects on the product quality as compared to the expensive and lengthy startup and shutdown procedures of continuous distillation processes which critically effect product quality. The operation and control can easily be shifted from one operator to another and does not require precise controls that must be constantly monitored and adjusted.

What is claimed is:

1. A batch distillation system for the treatment and refining of used oil and recovery of usable components therefrom which comprises:
a) a batch mixing and distillation tank for combining pretreatment chemicals and used oil feed stock to form a mixture for heating under reduced pressure;
b) an inlet operatively connected to the mixing tank for adding the pretreatment chemicals and used oil feedstock to the mixing tank;
c) a pressure reducing apparatus operatively connected to the mixing tank for creating and maintaining a reduced pressure throughout said system;
d) a mixer operatively connected to the mixing tank for vigorously mixing the mixture;
e) a heater operatively connected to the mixing tank for heating the mixture in a controlled manner;
f) a distillate outlet operatively connected to the mixing tank for allowing vapors distilled from the mixture to exit the tank;
g) a condenser operatively connected to the distillate outlet for receiving, cooling and condensing the vapor to a distillate which is at least partially condensed;
h) a collector operatively connected to the condenser to receive distillate for storage or further use; and
i) a residual outlet line connected to said mixing tank for removing residual bottoms from the mixing tank following collection of the distillate in the collector.

2. The batch distillation system of claim 1, wherein the collector further comprises a first collection vessel for collection of a first aqueous distillate, a second collection vessel for collecting a light hydrocarbon distillate and a third collection vessel for collecting a base oil distillate with the proviso that only one collection vessel is open to collection of distillate from the condenser at a time and the collection vessels are connected in series.

3. The batch distillation system of claim 2, wherein said first collection vessel is operatively connected with said condenser to circulate cooled aqueous distillate through the condenser as a cooling liquid.

4. The batch distillation system of claim 2, wherein said second collection vessel is operatively connected with the heater such that the light hydrocarbon distillate in said second collection vessel is utilized as fuel for heating the mixture in the mixing tank.

5. The batch distillation system of claim 2, wherein said third collection vessel is operatively connected to an extraction vessel wherein said base oil distillate is subjected to solvent extraction to remove impurities in said base oil distillate.

6. The batch distillation system of claim 1, wherein said pressure reducing apparatus in the system is a vacuum pump.

7. The batch distillation system of claim 1, wherein said mixing tank has a pretreatment chemical and used oil feed stock capacity of about 2,000 to 20,000 gallons.

8. The batch distillation system of claim 1, wherein said heater has the capacity and ability for the controlled heating of the mixture in the mixing tank from about 100° to 750° F.

9. The batch distillation system of claim 1, wherein said pressure reducing apparatus has the capacity to maintain the system under a reduced pressure of about 15 to 28 in Hg.

10. A method for separating used oil into usable fractions comprising the steps of:
a) forming a mixture of used oil and pretreatment chemicals in a batch mixing tank which is maintained under a reduced pressure and causing said mixture to be mixed and de-emulsification to begin;
b) raising the temperature of said mixture at a predetermined rate to a first temperature range wherein de-emulsification and mixing of said mixture continues and an aqueous fraction is distilled therefrom and removed from the mixing tank into a condenser where distilled vapors are condensed as an aqueous distillate and collected;
c) again raising the temperature of said mixture at a predetermined rate to a second temperature range wherein a light hydrocarbon fraction is distilled therefrom and removed from the mixing tank into the condenser where distilled light hydrocarbon vapors are condensed as a light hydrocarbon distillate and collected;
d) again raising the temperature of said mixture at a predetermined rate to a third temperature range wherein a base oil fraction is distilled therefrom and removed from the mixing tank into the condenser where distilled base oil vapors are condensed as a base oil distillate and collected thereby leaving a residual asphaltic bottoms fraction in the mixing tank; and
e) removing said residual bottoms from the mixing tank.

11. The method of claim 10, wherein the pretreatment chemicals comprise diesel fuel and, optionally, one or more chemicals selected from the group consisting of naptha, gasoline, propane, pentane, hexane, lubricating oil, methanol, isopropyl alcohol, a surface active agent, water and any combination thereof.

12. The method of claim 11, wherein the pretreatment chemical is diesel fuel only.

13. The method of claim 11, wherein the pretreatment chemical contains naptha.

14. The method of claim 11, wherein the pretreatment chemical contains a surface active agent.

15. The method of claim 14, wherein the surface active agent is an ethoxylated alkyl phenol.

16. The method of claim 11, wherein said first temperature range is about 100° to 200° F.

17. The method of claim 11, wherein said second temperature range is about 200° to 500° F.

18. The method of claim 11, wherein said third temperature range is about 500° to 700° F.

19. The method of claim 11, wherein said collected aqueous distillate is circulated to the condenser as a cooling medium.

20. The method of claim 11, wherein said light hydrocarbon distillate is utilized as fuel for raising the temperature to the first, second and third temperature ranges.

21. The method of claim 11, wherein said base oil distillate is subjected to solvent extraction to remove impurities from and improve the color of said base oil.

22. The method of claim 21, wherein the solvent utilized in said extraction is a mixture of N-methyl pyrrolidone (NMP) and a polar solvent selected from the group consisting of methanol, ethanol, propanol, isopropanol, water and mixtures thereof.

23. The method of claim 22, wherein said solvent contains 50 to 90% by volume NMP and 10 to 50% by volume polar solvent.

24. The method of claim 23, wherein the ratio of base oil to solvent is from 4:1 to 2:1 by volume.

25. The method of claim 24, wherein the polar solvent is methanol.

26. The method of claim 25, wherein said solvent contains 75 to 90% by volume NMP and 10 to 25% by volume polar solvent.

27. The method of claim 24, wherein the polar solvent is water.
